(19) United States
(12) Patent Application Publication
(10) Pub. No.: US 2024/0377306 A1
(43) Pub. Date: Nov. 14, 2024

(54) MATERIAL ESTIMATION DEVICE, MATERIAL ESTIMATION SYSTEM, AND MATERIAL ESTIMATION METHOD

(71) Applicant: NEC Corporation, Minato-ku, Tokyo (JP)

(72) Inventor: Kan KIMURA, Tokyo (JP)

(73) Assignee: NEC Corporation, Minato-ku, Tokyo (JP)

(21) Appl. No.: 18/691,147

(22) PCT Filed: Sep. 29, 2021
(86) PCT No.: PCT/JP2021/035743

§ 371 Date: Mar. 12, 2024

(51) Int. Cl. G01N 15/0205; G01S 7/48; G01S 17/32

(52) U.S. Cl. CPC G01N 15/0211; G01S 7/4802; G01S 17/32

(57) ABSTRACT

Provided are a material estimation device, etc., whereby the material of an object can be estimated on the basis of particle size of the object. A material estimation device (2) comprises: an information acquisition means (21) for acquiring particle size estimation information used to estimate the size of particles in a particulate body constituting an object, on the basis of laser light radiated to the object and reflected light reflected by the object; a particle size estimation means (22) for estimating the size of particles in the particulate body using the particle size estimation information; and a material estimation means (23) for estimating the material of the object on the basis of the result of estimation by the particle size estimation means.

### TECHNICAL FIELD

The present invention relates to a material estimation device and the like.

### BACKGROUND ART

PTL 1 discloses a technique of determining whether a target object (for example, a product or a target to be handled by a robot) is covered with a semi-transparent container, by using a time-of-flight (ToF) distance sensor. The distance sensor uses a laser (see paragraph [0019] of PTL 1.) As related-art techniques, techniques described in PTL 2 and PTL 3 are also known.

### CITATION LIST

### Patent Literature

PTL 1: International Patent Publication No. WO2015/125478

PTL 2: Japanese Unexamined Patent Application Publication No. 2016-188822

PTL 3: International Patent Publication No. WO2016/152288

### SUMMARY OF INVENTION

### Technical Problem

As described above, the technique described in PTL 1 determines whether an object being a target (hereinafter, also referred to as a “target object”) is covered with a semi-transparent container. Specifically, when the target object is composed of a particulate body, the technique described in PTL 1 does not estimate a material of the target object, based on a size of a particle in the particulate body (hereinafter, also referred to as a “particle size” or “a size of particle”). In other words, the technique described in PTL 1 does not include a means for estimating a material of a target object, based on a particle size of the target object. Thus, according to the technique described in PTL 1, there is a problem that a material of a target object cannot be estimated based on a particle size of the target object.

In view of the problem described above, an object of the present invention is to provide a material estimation device and the like that are capable of estimating a material of a target object, based on a particle size of the target object.

### Solution to Problem

A material estimation device according to the present invention includes an information acquisition means for acquiring information to be used for estimating a size of a particle in a particulate body constituting a target object, based on laser light with which the target object is irradiated and reflected light reflected by the target object, a particle size estimation means for estimating a size of a particle in the particulate body by using the information to be used for estimating a size of a particle, and a material estimation means for estimating a material of the target object, based on a result of the estimation by the particle size estimation means.

A material estimation system according to the present invention includes an information acquisition means for acquiring information to be used for estimating a size of a particle in a particulate body constituting a target object, based on laser light with which the target object is irradiated and reflected light reflected by the target object, a particle size estimation means for estimating a size of a particle in the particulate body by using the information to be used for estimating a size of a particle, and a material estimation means for estimating a material of the target object, based on a result of the estimation by the particle size estimation means.

A material estimation method according to the present invention includes acquiring, by an information acquisition means, information to be used for estimating a size of a particle in a particulate body constituting a target object, based on laser light with which the target object is irradiated and reflected light reflected by the target object, estimating, by a particle size estimation means, a size of a particle in the particulate body by using the information to be used for estimating a size of a particle, and estimating, by a material estimation means, a material of the target object, based on a result of the estimation by the particle size estimation means.

### Advantageous Effects of Invention

According to the present invention, it is possible to provide a material estimation device and the like that are capable of estimating a material of a target object, based on a particle size of the target object.

### BRIEF DESCRIPTION OF DRAWINGS

FIG. 1 is a block diagram illustrating a material estimation system according to a first example embodiment.

FIG. 2 is a block diagram illustrating a LiDAR device of the material estimation system according to the first example embodiment.

FIG. 3 is a block diagram illustrating a material estimation device according to the first example embodiment.

FIG. 4 is a block diagram illustrating an output device of the material estimation system according to the first example embodiment.

FIG. 5 is a block diagram illustrating a hardware configuration of the material estimation device according to the first example embodiment.

FIG. 6 is a block diagram illustrating another hardware configuration of the material estimation device according to the first example embodiment.

FIG. 7 is a block diagram illustrating another hardware configuration of the material estimation device according to the first example embodiment.

FIG. 8 is a flowchart illustrating an operation of the material estimation device according to the first example embodiment.

FIG. 9 is a block diagram illustrating a material estimation system according to a second example embodiment.

FIG. 10 is a block diagram illustrating a material estimation device according to the second example embodiment.

FIG. 11 is a flowchart illustrating an operation of the material estimation device according to the second example embodiment.

FIG. 12 is a block diagram illustrating a material estimation device according to a third example embodiment.

FIG. 13 is a block diagram illustrating a material estimation system according to the third example embodiment.

### EXAMPLE EMBODIMENT

Hereinafter, example embodiments of the present invention are described with reference to the drawings.

### First Example Embodiment

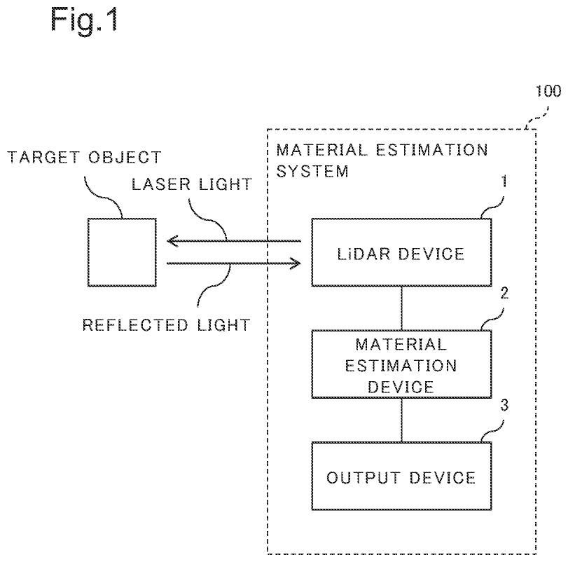

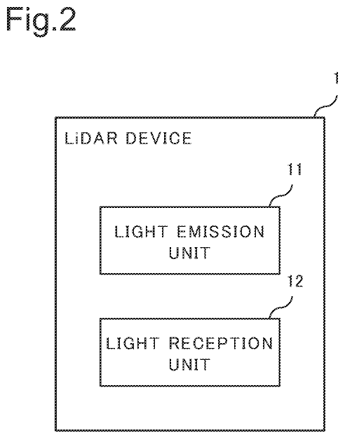

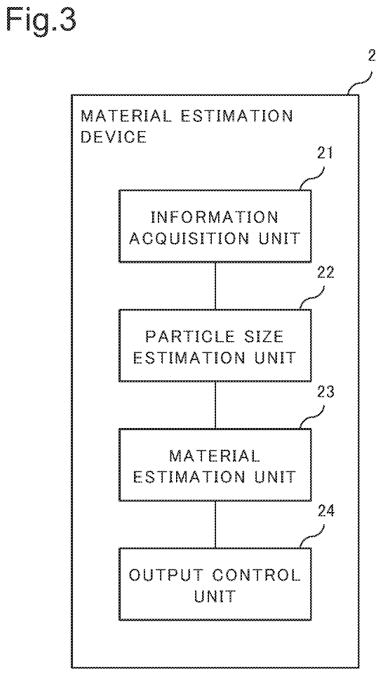

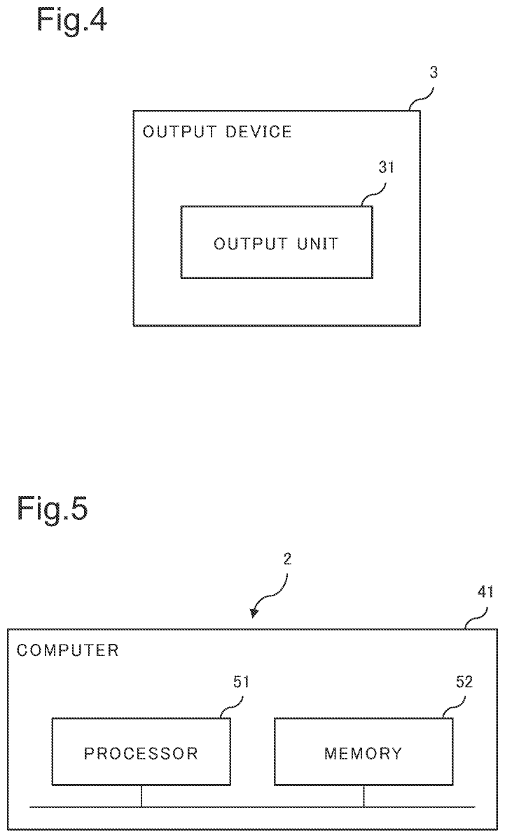

FIG. 1 is a block diagram illustrating a material estimation system according to a first example embodiment. FIG. 2 is a block diagram illustrating a LiDAR device of the material estimation system according to the first example embodiment. FIG. 3 is a block diagram illustrating a material estimation device according to the first example embodiment. FIG. 4 is a block diagram illustrating an output device of the material estimation system according to the first example embodiment. With reference to FIG. 1 to FIG. 4, the material estimation system according to the first example embodiment is described.

As illustrated in FIG. 1, a material estimation system 100 includes a LiDAR device 1 and a material estimation device 2. Specifically, as illustrated in FIG. 1, the material estimation system 100 includes the LiDAR device 1. As illustrated in FIG. 2, the LiDAR device 1 includes a light emission unit 11 and a light reception unit 12. The light emission unit 11 is configured by an optical transmitter for LiDAR. The light reception unit 12 is configured by an optical receiver for LiDAR. The LiDAR device 1 may include a signal processing unit (omitted in illustration) for LiDAR, in addition to the light emission unit 11 and the light reception unit 12. The signal processing unit is configured by a dedicated circuit, for example.

The light emission unit 11 emits laser light toward a target object. The target object is irradiated with the laser light being emitted. Herein, in the LiDAR device 1, an emission direction of the laser light from the light emission unit 11 can be changed. The light emission unit 11 emits the laser light to a plurality of directions. With this, irradiation with the laser light is performed in such a way as to scan the target object. The laser light with which irradiation is performed is reflected by the target object. A back-scattering component (that is, back-scattering light) in the light being reflected (hereinafter, also referred to as “reflected light”) is received by the light reception unit 12. Hereinafter, the light of the reflected light, which is received by the light reception unit 12, is also referred to as “reception light”.

Herein, the target object is composed of an aggregation of minute individual particles. Specifically, the target object is composed of a particulate body. Specifically, for example, the target object is a pile of raw materials in a raw material yard or a concrete product. For example, the pile of raw materials is a sand pile or a gravel pile. For example, the concrete product is a concrete road, a concrete wall, or a concrete block.

As illustrated in FIG. 1, the material estimation system 100 includes the material estimation device 2. The material estimation device 2 is communicably connected to the LiDAR device 1 in a wired or wireless manner. As described later with reference to FIG. 5 to FIG. 7, the material estimation device 2 is configured by a computer. The computer may be provided to a so-called “cloud”. As illustrated in FIG. 3, the material estimation device 2 includes an information acquisition unit 21, a particle size estimation unit 22, a material estimation unit 23, and an output control unit 24.

In general, the following information is acquired based on the laser light that is emitted from the LiDAR device 1 (that is, the laser light with which the target object is irradiated) and the reflected light that is received by the LiDAR device 1 (that is, the reception light). Specifically, information indicating a distance D between a location of a point at which the LiDAR device 1 is installed and a location of a point at which the laser light emitted in each direction is reflected by an object (including the target object) (hereinafter, also referred to as a “reflection point”) is acquired. For example, the information is used for estimating a shape of the target object. Hereinafter, the information is also referred to as “distance information” or “first information”.

Meanwhile, the information acquisition unit 21 acquires information different from the distance information, based on the laser light that is emitted from the LiDAR device 1 (that is, the laser light with which the target object is irradiated) and the reflected light that is received by the LiDAR device 1 (that is, the reception light). The information is used by the particle size estimation unit 22, which is described later, for estimating a size of a particle in a particulate body constituting the target object. In other words, the information is used for estimating a size of a particle (that is, a particle size) of the target object. Hereinafter, the information is also referred to as “particle size estimation information” or “second information”.

Specifically, for example, the particle size estimation information may include information indicating intensity of the reception light associated with the laser light emitted in each direction (hereinafter, also referred to as “intensity information”). Specifically, the information acquisition unit 21 detects intensity of the reception light. With this, the intensity information indicating the intensity being detected is acquired by the information acquisition unit 21. When the LiDAR device 1 includes a signal processing unit, the intensity of the reception light may be detected by the signal processing unit of the LiDAR device 1 instead of the information acquisition unit 21. In this case, the LiDAR device 1 may output the intensity information, and the information acquisition unit 21 may acquire the intensity information being output.

Further, the particle size estimation information may include information indicating polarization of the reception light associated with the laser light emitted in each direction (hereinafter, also referred to as “polarization information”). Specifically, in this case, the LiDAR device 1 includes a function of detecting polarization of the reception light. The LiDAR device 1 outputs the information indicating the polarization being detected (that is, the polarization information). The information acquisition unit 21 acquires the polarization information being output.

Further, the particle size estimation information may include frequency deviation of the reception light associated with the laser light emitted in each direction (hereinafter, also referred to as “frequency deviation information”). Specifically, the information acquisition unit 21 detects frequency deviation of the reception light, based on a frequency component included in the reception light. With this, the information acquisition unit 21 acquires the frequency deviation information indicating the frequency deviation being detected. When the LiDAR device 1 includes a signal processing unit, the frequency deviation of the reception light may be detected by the signal processing unit of the LiDAR device 1 instead of the information acquisition unit 21. In this case, the LiDAR device 1 may output the frequency deviation information, and the information acquisition unit 21 may acquire the frequency deviation information being output.

Further, with regard to a plurality of distances D associated with a plurality of emission directions, the particle size estimation information may include information indicating a statistic value (for example, dispersion) of the plurality of distances D (hereinafter, also referred to as “statistic value information”). Specifically, the information acquisition unit 21 calculates each of the plurality of distances D. For example, ToF or Frequency Modulated Continuous Wave (FMCW) is used for calculating each of the distances D. The information acquisition unit 21 calculates the statistic value, based on the distances D being calculated. With this, the information acquisition unit 21 acquires the statistic value information indicating the statistic value being calculated. When the LiDAR device 1 includes a signal processing unit, the statistic value may be detected by the signal processing unit of the LiDAR device 1 instead of the information acquisition unit 21. In this case, the LiDAR device 1 may output the statistic value information, and the information acquisition unit 21 may acquire the statistic value information being output.

Specifically, the particle size estimation information includes at least one of the intensity information, the polarization information, the frequency deviation information, and the statistic value information. In this manner, the particle size estimation information is information acquired by using the LiDAR device 1, and information different from the first information (that is, the distance information) relating to the distance D.

The particle size estimation unit 22 estimates a size of a particle in a particulate body in the target object by using the particle size estimation information acquired by the information acquisition unit 21. In other words, the particle size estimation unit 22 estimates a size of a particle (that is, a particle size) of the target object.

Specifically, it is assumed that, according to the particle size of the target object, the intensity of the reception light associated therewith is changed. Further, it is assumed that, according to the particle size of the target object, the polarization of the reception light associated therewith is changed. Further, it is assumed that, according to the particle size of the target object, the frequency deviation of the reception light associated therewith is changed. Further, it is assumed that, according to the particle size of the target object, the statistic value of the distance D associated therewith is changed.

In view of this, for example, a database indicating a correlation between at least one of the intensity of the reception light, the polarization of the reception light, the frequency deviation of the reception light, and the statistic value of the distance D and the particle size of the target object is prepared in advance (hereinafter, also referred to as a “first database”). The first database may be stored inside the material estimation device 2, or may be stored in an external device (omitted in illustration). The particle size estimation unit 22 estimates the particle size of the target object by using the above-mentioned particle size estimation information being acquired, based on the first database.

The first database may be updated based on the information used for the estimation by the particle size estimation unit 22 (that is, the above-mentioned particle size estimation information being acquired) and a result of the estimation by the particle size estimation unit 22. The first database may be updated inside the material estimation device 2. Alternatively, the first database may be updated in an external device (omitted in illustration).

Alternatively, for example a model that outputs a value indicating the particle size of the target object when a value indicating at least one of the intensity of the reception light, the polarization of the reception light, the frequency deviation of the reception light, and the statistic value of the distance D is input is prepared in advance (hereinafter, also referred to as a “first model”). The first model may be stored inside the material estimation device 2, or may be stored in an external device (omitted in illustration). The particle size estimation unit 22 inputs, to the first model, a value associated with the above-mentioned particle size estimation information being acquired. In response to the input, the first model outputs a value indicating the particle size of the target object to the particle size estimation unit 22. The particle size estimation unit 22 determines the particle size of the target object, based on the value that is output from the first model. Herein, for example, the first model is a predetermined statistical model or a machine learning model that is generated in advance through machine learning. The machine learning model is generated through, for example, supervised learning. For example, the supervised learning uses learning data associated with at least one of the intensity of the reception light, the polarization of the reception light, the frequency deviation of the reception light, and the statistic value of the distance D and ground truth associated with the particle size of the target object.

The first model may be updated based on the information used for the estimation by the particle size estimation unit 22 (that is, the above-mentioned particle size estimation information being acquired) and the result of the estimation by the particle size estimation unit 22. The first model may be updated inside the material estimation device 2. Alternatively, the first model may be updated in an external device (omitted in illustration). When the first model is a machine learning model, the external device is a computer dedicated for machine learning, for example. The computer may update a structure of the first model or a value of each parameter (for example, a weight) in the first model.

The material estimation unit 23 estimates a material of the target object, based on the result of the estimation by the particle size estimation unit 22.

Specifically, for example, a database indicating a correlation between the particle size of the target object and the material (sand, gravel, concrete, or the like) of the target object is prepared in advance (hereinafter, also referred to as a “second database”). The second database may be stored inside the material estimation device 2, or may be stored in an external device (omitted in illustration). The material estimation unit 23 acquires information indicating the result of the estimation by the particle size estimation unit 22 (hereinafter, also referred to as “particle size information”). The material estimation unit 23 determines the material of the target object by using the particle size information being acquired, based on the second database.

The second database may be updated based on the information used for the estimation by the material estimation unit 23 (that is, the above-mentioned particle size information being acquired) and a result of the estimation by the material estimation unit 23. The second database may be updated inside the material estimation device 2. Alternatively, the second database may be updated in an external device (omitted in illustration).

Alternatively, for example, a model that outputs a value indicating the material of the target object when a value indicating the particle size of the target object is input is prepared in advance (hereinafter, also referred to as a “second model”). The second model may be stored inside the material estimation device 2, or may be stored in an external device (omitted in illustration). The material estimation unit 23 acquires the particle size information. The material estimation unit 23 inputs, to the second model, a value associated with the particle size information being acquired. In response to the input, the second model outputs a value indicating the material of the target object to the material estimation unit 23. The material estimation unit 23 determines the material of the target object, based on the value that is output from the second model. Herein, for example, the second model is a predetermined statistical model or a machine learning model that is generated in advance through machine learning. The machine learning model is generated through supervised learning, for example. For example, the supervised learning uses learning data associated with the particle size of the target object and ground truth associated with the material of the target object.

The second model may be updated based on the information used for the estimation by the material estimation unit 23 (that is, the above-mentioned particle size information being acquired) and the result of the estimation by the material estimation unit 23. The second model may be updated inside the material estimation device 2. Alternatively, the second model may be updated in an external device (omitted in illustration). The second model is a machine learning model, the external device is a computer dedicated for machine learning, for example. The computer may update a structure of the second model or a value of each parameter (for example, a weight) in the second model.

For example, it is assumed that candidates for the target object include a sand pile, a gravel pile, and a concrete product. Further, it is assumed that the second database or the second model includes a value indicating a particle size associated with sand, a value indicating a particle size associated with gravel, and a value indicating a particle size associated with concrete. In this case, the material estimation unit 23 determines whether the material of the target object is sand, gravel, or concrete, by using the above-mentioned particle size information being acquired. With this, it is determined that the target object is any one of a sand pile, a gravel pile, and a concrete product.

The output control unit 24 executes control for outputting information indicating the result of the estimation by the material estimation unit 23 (hereinafter, also referred to as “material information”). Specifically, the material information includes information indicating the material of the target object. An output device 3, which is described later, is used for outputting the material information (see FIG. 1).

Specifically, for example, the output control unit 24 executes control for displaying an image associated with the material information. The image may be displayed by using a predetermined graphical user interface (GUI). Alternatively, for example, the output control unit 24 executes control for outputting a sound associated with the material information. With this, a person can be notified of the material of the target object. Alternatively, for example, the output control unit 24 executes control for transmitting a signal associated with the material information to another device (omitted in illustration) or another system (omitted in illustration). A predetermined application programming interface (API) may be used for providing the material information through signal transmission. With this, another device or another system can be notified of the material of the target object.

As illustrated in FIG. 1, the material estimation system 100 includes the output device 3. The output device 3 is communicably connected to the material estimation device 2 in a wired or wireless manner. As illustrated in FIG. 4, the output device 3 includes an output unit 31. The output unit 31 outputs the material information, under control of the output control unit 24. For example, the output unit 31 is configured by at least one of a display, a speaker, and a transceiver. In other words, the output device 3 is configured by at least one of a display device, a sound output device, and a communication device.

In this manner, the material estimation system 100 is configured.

Hereinafter, the light emission unit 11 is also referred to as a “light emission means”. Further, the light reception unit 12 is also referred to as a “light reception means”. Further, the information acquisition unit 21 is also referred to as an “information acquisition means”. Further, the particle size estimation unit 22 is also referred to as a “particle size estimation means”. Further, the material estimation unit 23 is also referred to as a “material estimation means”. Further, the output control unit 24 is also referred to as an “output control means”.

Next, with reference to FIG. 5 to FIG. 7, a hardware configuration of the material estimation device 2 is described.

As illustrated in each of FIG. 5 to FIG. 7, the material estimation device 2 is achieved by using a computer 41.

As illustrated in FIG. 5, the computer 41 includes a processor 51 and a memory 52. The memory 52 stores a program that causes the computer 41 to function as the information acquisition unit 21, the particle size estimation unit 22, the material estimation unit 23, and the output control unit 24. The processor 51 reads out and executes the program stored in the memory 52. With this, a function F1 of the information acquisition unit 21, a function F2 of the particle size estimation unit 22, a function F3 of the material estimation unit 23, and a function F4 of the output control unit 24 are achieved.

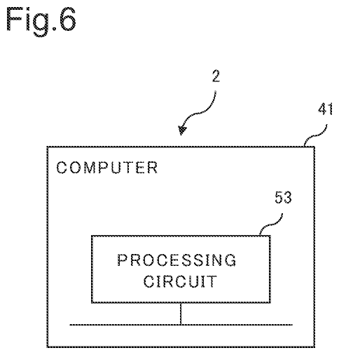

Alternatively, as illustrated in FIG. 6, the computer 41 includes a processing circuit 53. The processing circuit 53 executes processing of causing the computer 41 to function as the information acquisition unit 21, the particle size estimation unit 22, the material estimation unit 23, and the output control unit 24. With this, the functions F1 to F4 are achieved.

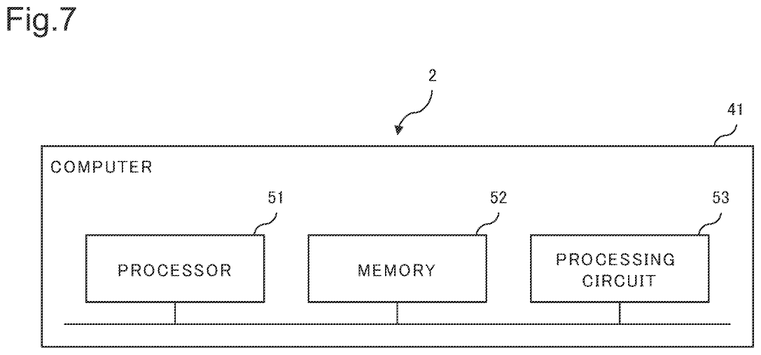

Alternatively, as illustrated in FIG. 7, the computer 41 includes the processor 51, the memory 52, and the processing circuit 53. In this case, some functions of the functions F1 to F4 are achieved by the processor 51 and the memory 52, and the remaining functions of the functions F1 to F4 are achieved by the processing circuit 53.

The processor 51 is configured by one or more processors. Each of the processors is achieved by using a central processing unit (CPU), a graphics processing unit (GPU), a microprocessor, a micro controller, or a digital signal processor (DSP), for example.

The memory 52 is configured by one or more memories. Each of the memories is achieved by using a volatile memory or a non-volatile memory. Specifically, each of the memories is achieved by using a random access memory (RAM), a read only memory (ROM), a flash memory, an erasable programmable read only memory (EPROM), an electrically erasable programmable read only memory (EEPROM), a solid state drive, a hard disk drive, a flexible disk drive, a compact disk drive, a digital versatile disc (DVD), a Blu-ray disc, a magneto optical disc (MO), or a mini disc, for example.

The processing circuit 53 is configured by one or more processing circuits. Each of the processing circuits is achieved by using an application specific integrated circuit (ASIC), a programmable logic device (PLD), a field programmable gate array (FPGA), a system on a chip (SoC), or a large scale integration (LSI), for example.

The processor 51 may include a dedicated processor associated each of the functions F1 to F4. The memory 52 may include a dedicated memory associated with each of the functions F1 to F4. The processing circuit 53 may include a dedicated processing circuit associated with each of the functions F1 to F4.

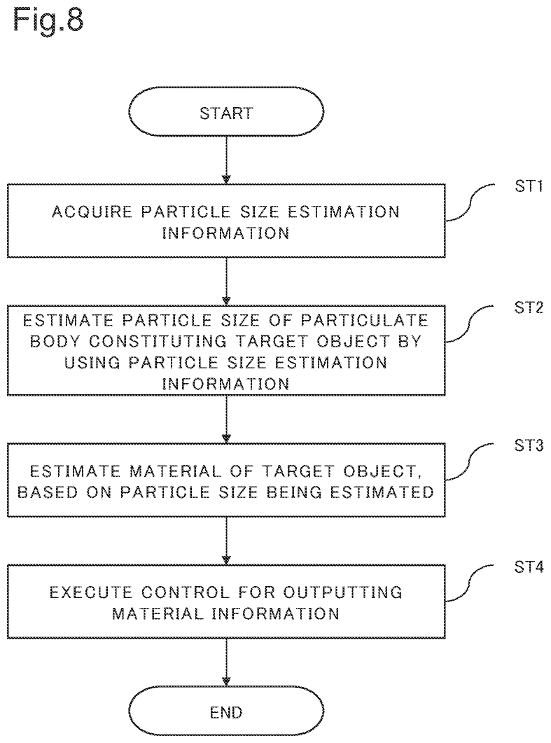

Next, an operation of the material estimation system 100 is described. More specifically, with reference to the flowchart illustrated in FIG. 8, an operation of the material estimation device 2 is mainly described.

First, the information acquisition unit 21 acquires the particle size estimation information (step ST1). The specific example of the particle size estimation information is as described above. Thus, the redundant description is omitted.

Subsequently, the particle size estimation unit 22 estimates a particle size of a particulate body constituting the target object by using the particle size estimation information that is acquired in step STI (step ST2). The specific example of the particle size estimation method is as described above. Thus, the redundant description is omitted.

Subsequently, the material estimation unit 23 estimates the material of the target object, based on the result of the estimation in step ST2 (step ST3). The specific example of the material estimation method is as described above. Thus, the redundant description is omitted.

Subsequently, the output control unit 24 executes control for outputting the material information, based on the result of the estimation in step ST3 (step ST4). With this, the material information is output.

Next, a modification example of the material estimation system 100 is described.

The particle size estimation information is not limited to the above-mentioned specific examples. The particle size estimation information may include any information as long as the information is acquired by using the LiDAR device 1, is different from the distance information, and is used for estimating the particle size of the target object.

The particle size estimation method performed by the particle size estimation unit 22 is not limited to the above-mentioned specific example. The estimation method may be any method as long as the particle size of the target object is estimated by using the above-mentioned particle size estimation information being acquired.

The material estimation method performed by the material estimation unit 23 is not limited to the above-mentioned specific example. The estimation method may be any method as long as the material of the target object is estimated based on the particle size of the target object.

The material estimation device 2 may include the light emission unit 11 and the light reception unit 12. In this case, the LiDAR device 1 is not required. In other words, the material estimation device 2 may be configured integrally with the LiDAR device 1.

The material estimation device 2 may include the output unit 31. In this case, the output device 3 is not required. In other words, the material estimation device 2 may be configured integrally with the output device 3.

The database used for the estimation by the material estimation device 2 is not limited to the first database and the second database. For example, the following database (hereinafter, also referred to as a “third database”) may be generated based on a history of the second information acquired by the information acquisition unit 21 and a history of the result of the estimation by the material estimation unit 23. Specifically, the third database is a database indicating a correlation between at least one of the intensity of the reception light, the polarization of the reception light, the frequency deviation of the reception light, and the statistic value of the distance D and the material of the target object. The third database may be generated inside the material estimation device 2, or may be generated in an external device (omitted in illustration). After the third database is generated, the material estimation unit 23 estimates the material of the target object by using the second information acquired by the information acquisition unit 21, based on the third database being generated. Specifically, the second information in this case is used for estimating the material of the target object, instead of being used for estimating the particle size of the target object.

After the third database is generated, the third database being generated may be updated based on the second information acquired by the information acquisition unit 21 and the result of the estimation by the material estimation unit 23. The third database may be updated inside the material estimation device 2. Alternatively, the third database may be updated in an external device (omitted in illustration).

The model used for the estimation by the material estimation device 2 is not limited to the first model and the second model. For example, the following model (hereinafter, also referred to as a “third model”) may be generated based on the history of the second information acquired by the information acquisition unit 21 and the history of the result of the estimation by the material estimation unit 23. Specifically, the third model is a model that outputs a value indicating the material of the target object when a value indicating at least one of the intensity of the reception light, the polarization of the reception light, the frequency deviation of the reception light, and the statistic value of the distance D is input. The third model may be generated inside the material estimation device 2, or may be generated in an external device (omitted in illustration). The third model is generated through predetermined machine learning (for example, supervised learning). After the third model is generated, the material estimation unit 23 inputs, to the third model being generated, a value associated with the second information acquired by the information acquisition unit 21. In response to the input, the third model outputs a value indicating the material of the target object to the material estimation unit 23. The material estimation unit 23 estimates the material of the target object, based on the value that is output from the third model. Specifically, the second information in this case is used for estimating the material of the target object, instead of being used for estimating the particle size of the target object.

After the third model is generated, the third model being generated may be updated based on the second information acquired by the information acquisition unit 21 and the result of the estimation by the material estimation unit 23. The third model may be updated inside the material estimation device 2. Alternatively, the third model may be updated in an external device (omitted in illustration). The external device is a computer dedicated for machine learning, for example. The computer may update a structure of the third model or a value of each parameter (for example, a weight) in the third model.

Next, effects of the material estimation system 100 are described.

As described above, based on the laser light with which the target object is irradiated and the reflected light reflected by the target object, the information acquisition unit 21 acquires the particle size estimation information used for estimating a size of a particle (particle size) in a particulate body in the target object. The particle size estimation unit 22 estimates a size of a particle (particle size) in a particulate body by using the particle size estimation information. The material estimation unit 23 estimates the material of the target object, based on the result of the estimation by the particle size estimation unit 22.

In this manner, by using the laser light and the reflected light (that is, by using LiDAR), for example, the intensity of the reception light, the polarization of the reception light, or the frequency deviation of the reception light can be detected, or the statistic value of the distance D can be calculated. With this, the particle size estimation information can be acquired. Further, the particle size of the target object can be estimated by using the particle size estimation information being acquired. This is because the value of the parameter (for example, the intensity of the reception light, the polarization of the reception light, the frequency deviation of the reception light, or the statistic value of the distance D) included in the particle size estimation information is changed according to the particle size of the target object. As a result, the material of the target object can be estimated based on the particle size being estimated.

Further, the material estimation unit 23 estimates the material of the target object by using the predetermined database (the second database or the third database). The material estimation system 100 updates the database (the second database or the third database), based on the result of the estimation by the material estimation unit 23. For example, accuracy of the estimation by the material estimation unit 23 can be gradually improved by updating the database.

Further, the particle size estimation information includes at least one of the intensity information indicating the intensity of the reflected light being received, the polarization information indicating the polarization of the reflected light being received, the frequency deviation information indicating the frequency deviation of the reflected light being received, and the statistic value information indicating the statistic value of the distance D to the target object. By using those pieces of information, the particle size of the target object can be estimated.

Further, the material estimation system 100 outputs the information indicating the result of the estimation by the material estimation unit 23 (the material information). With this, a person can be notified of the material of the target object. Alternatively, another device or another system can be notified of the material of the target object.

### Second Example Embodiment

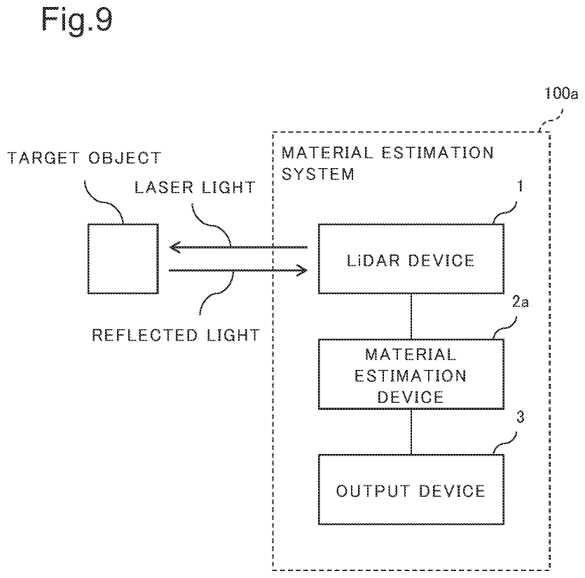

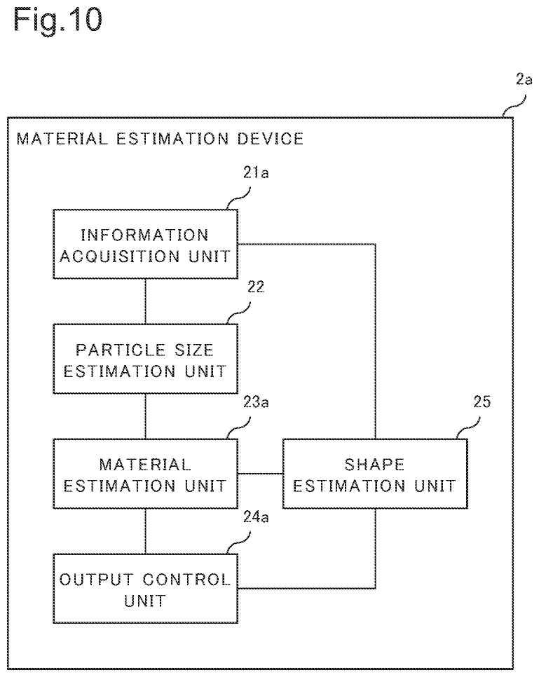

FIG. 9 is a block diagram illustrating a material estimation system according to a second example embodiment. FIG. 10 is a block diagram illustrating a material estimation device according to the second example embodiment. With reference to FIG. 9 and FIG. 10, the material estimation system according to the second example embodiment is described. In FIG. 9, a block similar to the block illustrated in FIG. 1 is denoted with the same reference symbol, and description thereof is omitted, Further, in FIG. 10, a block similar to the block illustrated in FIG. 3 is denoted with the same reference symbol, and description thereof is omitted.

As illustrated in FIG. 9, a material estimation system 100a includes the LiDAR device 1, a material estimation device 2a, and the output device 3. As illustrated in FIG. 10, the material estimation device 2a includes an information acquisition unit 21a, the particle size estimation unit 22, a material estimation unit 23a, an output control unit 24a, and a shape estimation unit 25.

The information acquisition unit 21a acquires the second information (that is, the particle size estimation information), based on the laser light that is emitted from the LiDAR device 1 (that is, the laser light with which the target object is irradiated) and the reflected light that is received by the LiDAR device 1 (that is, the reception light). In addition, the information acquisition unit 21a acquires the first information (that is, the distance information), based on those pieces of light.

Specifically, for example, the information acquisition unit 21a calculates the distance D by ToF. Specifically, in this case, the LiDAR device 1 emits pulse laser light in each direction. The information acquisition unit 21a calculates a one-way propagation distance (that is, the distance D) associated with a round-trip propagation time of those pieces of light, based on a time difference ΔT between a time T1 at which the LiDAR device 1 emits the laser light in each direction and a time T2 at which the LiDAR device 1 receives the reflected light associated therewith. With this, the distance information indicating the distance D is acquired.

Alternatively, for example, the information acquisition unit 21a calculates the distance D by FMCW. Specifically, in this case, the LiDAR device 1 includes a function of subjecting the laser light emitted in each direction to predetermined frequency modulation, a function of subjecting the reception light associated therewith to coherent detection, and the like. The information acquisition unit 21a calculates the distance D associated therewith, based on a frequency difference (a so-called “beat frequency”) between those pieces of light. In this manner, the distance information indicating the distance D is acquired.

In addition, various techniques that are publicly known may be used for acquiring the distance information. Detailed description for those techniques is omitted. For example, the distance D may be calculated based on a phase difference between the laser light being emitted and the reflected light being received (so-called “indirect ToF”).

When the LiDAR device 1 includes a signal processing unit, the distance D may be detected by the signal processing unit of the LiDAR device 1 instead of the information acquisition unit 21a. In this case, the LiDAR device 1 may output the distance information, and the information acquisition unit 21a may acquire the distance information being output.

Further, the plurality of distances D associated with the plurality of emission directions are calculated by generating the distance information. The statistic value information may be generated by using the plurality of distances D being calculated.

The shape estimation unit 25 estimates a shape of the target object (more specifically, an outer shape) by using the distance information acquired by the information acquisition unit 21a. Specifically, for example, the shape estimation unit 25 calculates a coordinate value indicating a location of each reflection point by using the distance information being acquired. The shape estimation unit 25 plots, in a virtual three-dimensional space, a point associated with the coordinate value being calculated. With this, a three-dimensional model that is composed of a point group is generated, the three-dimensional model being associated with the shape of the target object. In this manner, the shape of the target object is detected.

When an object other than the target object (for example, another object present in the periphery of the target object) is irradiated with the laser light, a point group associated with the another object may be plotted in addition to the point group associated with the target object. In such a case, the shape estimation unit 25 may classify the point groups, based on a distance between points, a result of plane detection, or the like, and thus may extract the point group associated with the target object from the point groups being plotted. With this, the shape estimation unit 25 may exclude the point group associated with the another object from the three-dimensional model.

The material estimation unit 23a estimates a material of the target object, based on the result of the estimation by the particle size estimation unit 22. The material estimation method in this case is similar to that described in the first example embodiment. Thus, the redundant description is omitted.

Alternatively, the material estimation unit 23a estimates the material of the target object, based on the result of the estimation by the particle size estimation unit 22 and a result of the estimation by the shape estimation unit 25. The estimation method is described below.

Specifically, for example, a database indicating a correlation between the particle size of the target object and the shape of the target object, and the material of the target object is prepared in advance (hereinafter, also referred to as a “fourth database”). The fourth database may be stored inside the material estimation device 2a, or may be stored in an external device (omitted in illustration). The material estimation unit 23a acquires the information indicating the result of the estimation by the particle size estimation unit 22 (that is, the particle size information), and also acquires information indicating the result of the estimation by the shape estimation unit 25 (hereinafter, also referred to as “shape information”). The material estimation unit 23a estimates the material of the target object by using the particle size information being acquired and the shape information being acquired, based on the fourth database.

The fourth database may be updated based on the information used for the estimation by the material estimation unit 23a (that is, the above-mentioned particle size information being acquired and the above-mentioned shape information being acquired) and the result of the estimation by the material estimation unit 23. The fourth database may be updated inside the material estimation device 2a. Alternatively, the fourth database may be updated in an external device (omitted in illustration).

Alternatively, for example, a model that outputs a value indicating the material of the target object when a value indicating the particle size of the target object and a value indicating the shape of the target object are input is prepared in advance (hereinafter, also referred to as a “fourth model”). The fourth model may be stored inside the material estimation device 2a, or may be stored in an external device (omitted in illustration). The material estimation unit 23a acquires the particle size information, and also acquires the shape information. The material estimation unit 23a inputs, to the fourth model, a value associated with the particle size information being acquired and a value associated with the shape information being acquired. In response to the input, the fourth model outputs a value indicating the material of the target object to the material estimation unit 23a. The material estimation unit 23a determines the material of the target object, based on the value that is output from the fourth model. Herein, for example, the fourth model is a predetermined statistical model or a machine learning model that is generated in advance through machine learning. The machine learning model is generated through supervised learning, for example. For example, the supervised learning uses learning data associated with the particle size of the target object and the shape of the target object and ground truth associated with the material of the target object.

The fourth model may be updated based on the information used for the estimation by the material estimation unit 23a (that is, the above-mentioned particle size information being acquired and the above-mentioned shape information being acquired) and a result of the estimation by the material estimation unit 23a. The fourth model may be updated inside the material estimation device 2a. Alternatively, the fourth model may be updated in an external device (omitted in illustration). The fourth model is a machine learning model, the external device is a computer dedicated for machine learning, for example. The computer may update a structure of the fourth model or a value of each parameter (for example, a weight) in the fourth model.

For example, it is assumed that candidates for the target object include a sand pile, a gravel pile, and a concrete product. In this case, it is highly likely that the target object can be determined as a pile of raw materials (sand pile or a gravel pile) or another object (a concrete product), based on the shape of the target object. Further, when the target object is a pile of raw materials, it is highly likely that the target object can be determined as sand pile or a gravel pile, based on the particle size of the target object. Specifically, it is possible to determine whether the target object is a sand pile, a gravel pile, or a concrete product, based on the particle size of the target object and the shape of the target object. In other words, it is possible to determine that the material of the target object is any one of sand, gravel, and concrete. The material estimation unit 23a can perform such determination by using the fourth database or the fourth model.

An example in which the material estimation unit 23a estimates the material of the target object, based on the result of the estimation by the particle size estimation unit 22 and the result of the estimation by the shape estimation unit 25 is mainly described below.

The output control unit 24a executes control for outputting information indicating the result of the estimation by the material estimation unit 23a (that is, the material information). In addition, the output control unit 24a may execute control for outputting information indicating the result of the estimation by the shape estimation unit 25 (that is, the shape information). Specifically, the output device 3 may output the shape information in addition to the material information. With this, a person can be notified of the material of the target object and the shape of the target object. Alternatively, another device (omitted in illustration) or another system (omitted in illustration) may be notified of the material of the target object and the shape of the target object.

An example in which the output control unit 24a executes control for outputting the material information and the shape information is mainly described below.

In this manner, the material estimation system 100a is configured.

Hereinafter, the information acquisition unit 21a is also referred to as an “information acquisition means”. Further, the material estimation unit 23a is also referred to as a “material estimation means”. Further, the output control unit 24a is also referred to as an “output control means”. Further, the shape estimation unit 25 is also referred to as a “shape estimation means”.

A hardware configuration of the material estimation device 2a is similar to that described with reference to FIG. 5 to FIG. 7 in the first example embodiment. Thus, detailed description is omitted.

Specifically, the material estimation device 2a includes a function F1a of the information acquisition unit 21a, the function F2 of the particle size estimation unit 22, a function F3a of the material estimation unit 23a, a function F4a of the output control unit 24a, and a function F5 of the shape estimation unit 25. The functions F1a, F2, F3a, F4a, and F5 may be achieved by the processor 51 and the memory 52, or may be achieved by the processing circuit 53.

Herein, the processor 51 may include a dedicated processor associated with each of the functions F1a, F2, F3a, F4a, and F5. The memory 52 may include a dedicated processor associated with each of the functions F1a, F2, F3a, F4a, and F5. The processing circuit 53 may include a dedicated processing circuit associated with each of the functions F1a, F2, F3a, F4a, and F5.

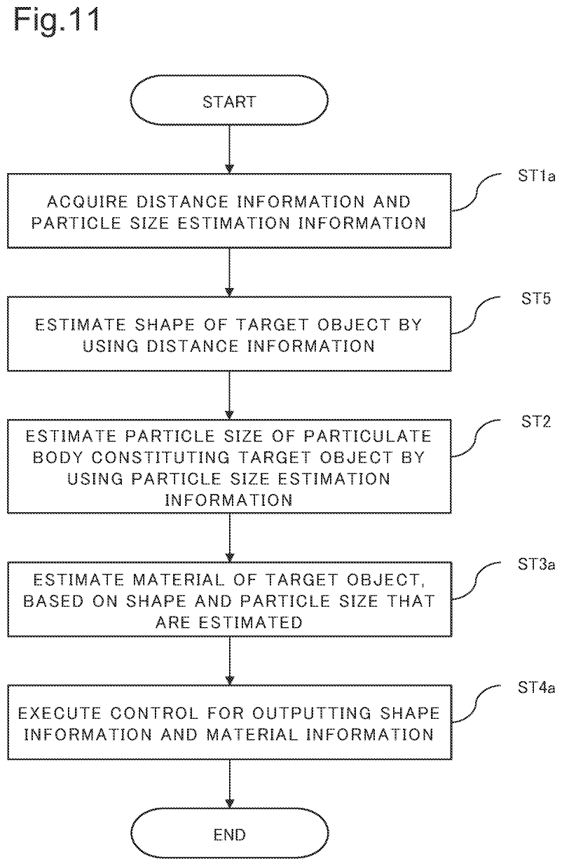

Next, an operation of the material estimation system 100a is described. More specifically, with reference to the flowchart illustrated in FIG. 11, an operation of the material estimation device 2a is mainly described. In FIG. 11, a step similar to the step illustrated in FIG. 8 is denoted with the same reference symbol.

First, the information acquisition unit 21a acquires the distance information and the particle size estimation information (step ST1a). The specific example of the distance information acquisition method is as described above. Further, the specific example of the particle size estimation information is as described in the first example embodiment. Thus, the redundant description is omitted.

Subsequently, the shape estimation unit 25 estimates the shape of the target object by using the distance information that is acquired in step ST1 (step ST5). The specific example of the shape estimation method is as described above. Thus, the redundant description is omitted.

Subsequently, the particle size estimation unit 22 estimates a particle size of a particulate body constituting the target object by using the particle size estimation information that is acquired in step ST1 (step ST2). The specific example of the particle size estimation method is as described in the first example embodiment. Thus, the redundant description is omitted.

The order of execution of the processing of step ST5 and the processing of step ST2 is freely selected. Specifically, as illustrated in FIG. 11, the processing of step ST2 may be executed subsequently to the processing of step ST5. Alternatively, the processing of step ST5 may be executed subsequently to the processing of step ST2. Alternatively, the processing of step ST5 and the processing of step ST2 may be executed simultaneously.

Subsequently, the material estimation unit 23a estimates the material of the target object, based on the result of the estimation in step ST5 and the result of the estimation in step ST2 (step ST3a). The specific example of the material estimation method is as described above. Thus, the redundant description is omitted.

Subsequently, the output control unit 24a executes control for outputting the shape information and the material information (step ST4a). With this, the shape information and the material information are output.

Next, a modification example of the material estimation system 100a is described.

Various modification examples similar to those described in the first example embodiment may be applied to the material estimation system 100a. In addition, the following modification examples may be applied to the material estimation system 100a.

The database used for the estimation by the material estimation device 2a is not limited to the first database and the fourth database. For example, the following database (hereinafter, also referred to as a “fifth database”) may be generated based on a history of the second information acquired by the information acquisition unit 21a, a history of the result of the estimation by the shape estimation unit 25, and a history of the result of the estimation by the material estimation unit 23a. Specifically, the fifth database is a database indicating a correlation between at least one of the intensity of the reception light, the polarization of the reception light, the frequency deviation of the reception light, and the statistic value of the distance D, the shape of the target object, and the material of the target object. The fifth database may be generated inside the material estimation device 2a, or may be generated in an external device (omitted in illustration). After the fifth database is generated, the material estimation unit 23a estimates the material of the target object by using the second information acquired by the information acquisition unit 21a and information indicating the result of the estimation by the shape estimation unit 25 (that is, the shape information), based on the fifth database being generated. Specifically, the second information in this case is used for estimating the material of the target object, instead of being used for estimating the particle size of the target object.

After the fifth database is generated, the fifth database being generated may be updated based on the second information acquired by the information acquisition unit 21a, the result of the estimation by the shape estimation unit 25, and the result of the estimation by the material estimation unit 23a. The fifth database may be updated inside the material estimation device 2a. Alternatively, the fifth database may be generated and updated in an external device (omitted in illustration).

The model used for the estimation by the material estimation device 2a is not limited to the first model and the fourth model. For example, the following model (hereinafter, also referred to as a “fifth model”) may be generated based on a history of the particle size estimation information that is acquired by the information acquisition unit 21a, the history of the result of the estimation by the shape estimation unit 25, and the history of the result of the estimation by the material estimation unit 23. Specifically, the fifth model is a value that outputs a value indicating the material of the target object when a value indicating at least one of the intensity of the reception light, the polarization of the reception light, the frequency deviation of the reception light, and the statistic value of the distance D, and a value indicating the shape of the target object are input. The fifth model may be generated inside the material estimation device 2a, or may be generated in an external device (omitted in illustration). The fifth model is generated through predetermined machine learning (for example, supervised learning). After the fifth model is generated, the material estimation unit 23a inputs, to the fifth model being generated, a value associated with the particle size estimation information acquired by the information acquisition unit 21 and a value associated with the result of the estimation by the shape estimation unit 25. In response to the input, the fifth model outputs a value indicating the material of the target object to the material estimation unit 23a. The material estimation unit 23a estimates the material of the target object, based on the value that is output from the fifth model. Specifically, the second information in this case is used for estimating the material of the target object, instead of being used for estimating the particle size of the target object.

After the fifth model is generated, the fifth model being generate maybe updated based on the particle size estimation information that is acquired by the information acquisition unit 21a, the result of the estimation by the shape estimation unit 25, and the result of the estimation by the material estimation unit 23a. The fifth model may be updated inside the material estimation device 2a. Alternatively, the fifth model may be generated and updated in an external device (omitted in illustration). The external device is a computer dedicated for machine learning, for example. The computer may update a structure of the fifth model or a value of each parameter (for example, a weight) in the fifth model.

Next, effects of the material estimation system 100a are described.

By using the material estimation system 100a, various effects similar to those described in the first example embodiment can be exerted. In addition, effects described below are exerted.

As described above, the information acquisition unit 21a further acquires the distance information relating to the distance D to the target object, based on the laser light and the reflected light. The shape estimation unit 25 estimates the shape of the target object by using the distance information. The material estimation unit 23a estimates the material of the target object, based on the result of the estimation by the shape estimation unit 25 and the result of the estimation by the particle size estimation unit 22.

In this manner, the distance D to each reflection point can be calculated by using the laser light and the reflected light (that is, by using LiDAR). With this, the distance information can be acquired. Further, the shape of the target object can be estimated by using the distance information being acquired. This is because a three-dimensional model of the target object can be generated, for example. Further, the result of the shape estimation can be used for estimating the material of the target object. When the material of the target object is estimated based on the shape of the target object and the particle size of the target object, the number of parameters used for the material estimation is increased as compared to a case in which the material of the target object is estimated based on the particle size of the target object. Thus, for example, accuracy of the material estimation can be improved.

Further, when the laser light and the reflected light are used (that is, by LiDAR is used), the particle size of the target object can be estimated by using the same device (for example, the LiDAR device 1) as the device used for estimating the shape of the target object (for example, the LiDAR device 1). With this, the number of devices included in the material estimation system 100a can be reduced as compared to a case in which a device used for the particle size estimation is different from a device used for the shape estimation. As a result, the configuration of the material estimation system 100a can be simplified.

### Third Example Embodiment

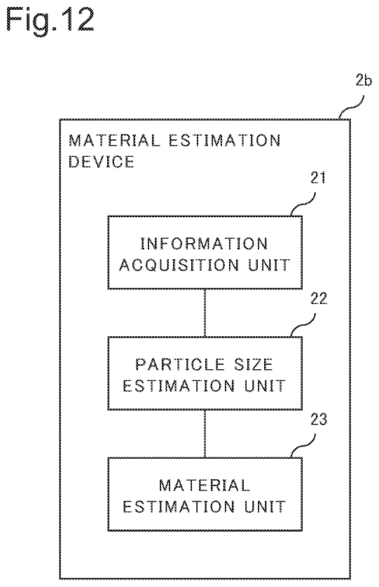

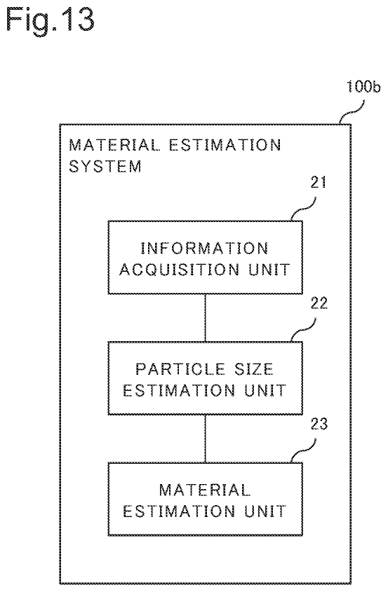

FIG. 12 is a block diagram illustrating a material estimation device according to a third example embodiment. With reference to FIG. 12, the material estimation device according to the third example embodiment is described. Further, FIG. 13 is a block diagram illustrating a material estimation system according to the third example embodiment. With reference to FIG. 13, the material estimation system according to the third example embodiment is described. In each of FIG. 12 and FIG. 13, a block similar to the block illustrated in FIG. 3 is denoted with the same reference symbol, and description thereof is omitted.

Herein, each of the material estimation device 2 according to the first example embodiment and the material estimation device 2a according to the second example embodiment is one example of a material estimation device 2b according to the third example embodiment. Further, each of the material estimation system 100 according to the first example embodiment and the material estimation system 100a according to the second example embodiment is one example of a material estimation system 100b according to the third example embodiment.

Specifically, as illustrated in FIG. 12, the material estimation device 2b includes the information acquisition unit 21, the particle size estimation unit 22, and the material estimation unit 23. In this case, the output control unit 24 may be provided outside of the material estimation device 2b.

Further, as illustrated in FIG. 13, the material estimation system 100b includes the information acquisition unit 21, the particle size estimation unit 22, and the material estimation unit 23. In this case, the LiDAR device 1 may be provided outside of the material estimation system 100b. In other words, the light emission unit 11 and the light reception unit 12 may be provided outside of the material estimation system 100b. Further, in this case, the output control unit 24 may be provided outside of the material estimation system 100b. Further, in this case, the output device 3 may be provided outside of the material estimation system 100b. In other words, the output unit 31 may be provided outside of the material estimation system 100b.

Even in those cases, effects similar to those described in the first example embodiment can be exerted.

Specifically, based on the laser light with which the target object is irradiated and the reflected light reflected by the target object, the information acquisition unit 21 acquires the particle size estimation information used for estimating a size of a particle (particle size) in a particulate body in the target object. The particle size estimation unit 22 estimates a size of a particle (particle size) in a particulate body by using the particle size estimation information. The material estimation unit 23 estimates the material of the target object, based on the result of the estimation by the particle size estimation unit 22.

In this manner, by using the laser light and the reflected light (that is, by using LiDAR), for example, the intensity of the reception light, the polarization of the reception light, or the frequency deviation of the reception light can be detected, or the statistic value of the distance D can be calculated. With this, the particle size estimation information can be acquired. Further, the particle size of the target object can be estimated by using the particle size estimation information being acquired. This is because the value of the parameter (for example, the intensity of the reception light, the polarization of the reception light, the frequency deviation of the reception light, or the statistic value of the distance D) included in the particle size estimation information is changed according to the particle size of the target object. As a result, the material of the target object can be estimated based on the particle size being estimated.

The material estimation device 2b may include the information acquisition unit 21a, the material estimation unit 23a, and the shape estimation unit 25, in place of the information acquisition unit 21 and the material estimation unit 23. Further, the material estimation system 100b may include the information acquisition unit 21a, the material estimation unit 23a, and the shape estimation unit 25, in place of the information acquisition unit 21 and the material estimation unit 23.

Further, the material estimation system 100b may include the light emission unit 11 and the light reception unit 12. Further, the material estimation system 100b may include the output control unit 24 or the output control unit 24a. Further, the material estimation system 100b may include the output unit 31.

Herein, each of the function units of the material estimation system 100b may be configured by an independent device. Those devices may be arranged in a geographically or network-wise distributed manner. For example, those devices may include an edge computer and a cloud computer.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or a part of the example embodiments described above can be described as, but not limited to, the following supplementary notes.

### Supplementary Notes

### Supplementary Note 1

A material estimation device including:
an information acquisition means for acquiring information to be used for estimating a size of a particle in a particulate body constituting a target object, based on laser light with which the target object is irradiated and reflected light reflected by the target object;
a particle size estimation means for estimating a size of a particle in the particulate body by using the information to be used for estimating a size of a particle; and
a material estimation means for estimating a material of the target object, based on a result of estimation by the particle size estimation means.

### Supplementary Note 2

The material estimation device according to Supplementary note 1, in which
the information acquisition means further acquires information relating to a distance to the target object, based on the laser light and the reflected light,
a shape estimation means for estimating a shape of the target object by using the information relating to a distance to the target object is further included, and
the material estimation means estimates a material of the target object, based on a result of estimation by the shape estimation means and a result of estimation by the particle size estimation means.

### Supplementary Note 3

The material estimation device according to Supplementary note 1 or 2, in which
the material estimation means estimates a material of the target object by using a predetermined database, and
the database is updated based on a result of estimation by the material estimation means.

### Supplementary Note 4

The material estimation device according to any one of Supplementary notes 1 to 3, in which
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

### Supplementary Note 5

The material estimation device according to any one of Supplementary notes 1 to 4, in which
information indicating a result of estimation by the material estimation means is output.

### Supplementary Note 6

A material estimation system including:
an information acquisition means for acquiring information to be used for estimating a size of a particle in a particulate body constituting a target object, based on laser light with which the target object is irradiated and reflected light reflected by the target object;
a particle size estimation means for estimating a size of a particle in the particulate body by using the information to be used for estimating a size of a particle; and
a material estimation means for estimating a material of the target object, based on a result of estimation by the particle size estimation means.

### Supplementary Note 7

The material estimation system according to Supplementary note 6, in which
the information acquisition means further acquires information relating to a distance to the target object, based on the laser light and the reflected light,
a shape estimation means for estimating a shape of the target object by using the information relating to a distance to the target object is further included, and
the material estimation means estimates a material of the target object, based on a result of estimation by the shape estimation means and a result of estimation by the particle size estimation means.

### Supplementary Note 8

The material estimation system according to Supplementary note 6 or 7, in which
the material estimation means estimates a material of the target object by using a predetermined database, and
the database is updated based on a result of estimation by the material estimation means.

### Supplementary Note 9

The material estimation system according to any one of Supplementary notes 6 to 8, in which
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

### Supplementary Note 10

The material estimation system according to any one of Supplementary notes 6 to 9, in which
information indicating a result of estimation by the material estimation means is output.

### Supplementary Note 11

A material estimation method including:
acquiring, by an information acquisition means, information to be used for estimating a size of a particle in a particulate body constituting a target object, based on laser light with which the target object is irradiated and reflected light reflected by the target object;
estimating, by a particle size estimation means, a size of a particle in the particulate body by using the information to be used for estimating a size of a particle; and
estimating, by a material estimation means, a material of the target object, based on a result of estimation by the particle size estimation means.

### Supplementary Note 12

The material estimation method according to Supplementary note 11, in which
the information acquisition means further acquires information relating to a distance to the target object, based on the laser light and the reflected light,
a shape estimation means estimates a shape of the target object by using the information relating to a distance to the target object, and
the material estimation means estimates a material of the target object, based on a result of estimation by the shape estimation means and a result of estimation by the particle size estimation means.

### Supplementary Note 13

The material estimation method according to Supplementary note 11 or 12, in which
the material estimation means estimates a material of the target object by using a predetermined database, and
the database is updated based on a result of estimation by the material estimation means.

### Supplementary Note 14

The material estimation method according to any one of Supplementary notes 11 to 13, in which
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

### Supplementary Note 15

The material estimation method according to any one of Supplementary notes 11 or 14, in which
information indicating a result of estimation by the material estimation means is output.

### Supplementary Note 16

A recording medium recording a program causing a computer to function as:
an information acquisition means for acquiring information to be used for estimating a size of a particle in a particulate body constituting a target object, based on laser light with which the target object is irradiated and reflected light reflected by the target object;
a particle size estimation means for estimating a size of a particle in the particulate body by using the information to be used for estimating a size of a particle; and
a material estimation means for estimating a material of the target object, based on a result of estimation by the particle size estimation means.

### Supplementary Note 17

The recording medium according to Supplementary note 16, in which
the information acquisition means further acquires information relating to a distance to the target object, based on the laser light and the reflected light,
the program causes the computer to function as a shape estimation means for estimating a shape of the target object by using the information relating to a distance to the target object, and
the material estimation means estimates a material of the target object, based on a result of estimation by the shape estimation means and a result of estimation by the particle size estimation means.

### Supplementary Note 18

The recording medium according to Supplementary note 16 or 17, in which
the material estimation means estimates a material of the target object by using a predetermined database, and
the program updates the database, based on a result of estimation by the material estimation means.

### Supplementary Note 19

The recording medium according to any one of Supplementary notes 16 to 18, in which
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

### Supplementary Note 20

The recording medium according to any one of Supplementary notes 16 to 19, in which
the program causes the computer to function as an output control means for executing control for outputting information indicating a result of estimation by the material estimation means.

### REFERENCE SIGNS LIST

1 LiDAR device
2, 2a, 2b Material estimation device
3 Output device
11 Light emission unit
12 Light reception unit
21, 21a Information acquisition unit
22 Particle size estimation unit
23, 23a Material estimation unit
24, 24a Output control unit
25 Shape estimation unit
31 Output unit
41 Computer
51 Processor
52 Memory
53 Processing circuit
100, 100a, 100b Material estimation system

What is claimed is:

1. A material estimation device comprising:
a memory configured to store instructions; and
at least one processor configured to execute the instructions to perform:
acquiring information to be used for estimating a size of a particle in a particulate body constituting a target object, based on laser light with which the target object is irradiated and reflected light reflected by the target object;
estimating a size of a particle in the particulate body by using the information to be used for estimating a size of a particle; and
estimating a material of the target object, based on a result of estimation.

2. The material estimation device according to claim 1, wherein
the at least one processor is configured to execute the instructions to perform:
acquires information relating to a distance to the target object, based on the laser light and the reflected light,
estimating a shape of the target object by using the information relating to a distance to the target object is further comprised, and
estimates a material of the target object, based on a result of estimation of the shape and a result of estimation of the particle size.

3. The material estimation device according to claim 1, wherein
the at least one processor is configured to execute the instructions to perform:
estimating a material of the target object by using a predetermined database, and
the database is updated based on a result of estimation of the material of the target object.

4. The material estimation device according to claim 1, wherein
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

5. The material estimation device according to claim 1, wherein
information indicating a result of estimation is output.

6. A material estimation system comprising:
a memory configured to store instructions; and
at least one processor configured to execute the instructions to perform:
acquiring information to be used for estimating a size of a particle in a particulate body constituting a target object, based on laser light with which the target object is irradiated and reflected light reflected by the target object;
estimating a size of a particle in the particulate body by using the information to be used for estimating a size of a particle; and
estimating a material of the target object, based on a result of estimation of the particle size.

7. The material estimation system according to claim 6, wherein
the at least one processor is configured to execute the instructions to perform:
acquiring information relating to a distance to the target object, based on the laser light and the reflected light,
estimating a shape of the target object by using the information relating to a distance to the target object is further comprised, and
estimating a material of the target object, based on a result of estimation of the shape and a result of estimation of the particle size.

8. The material estimation system according to claim 6, wherein
the at least one processor is configured to execute the instructions to perform:
estimating a material of the target object by using a predetermined database, and wherein
the database is updated based on a result of estimation of the material of the target object.

9. The material estimation system according to claim 6, wherein
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

10. The material estimation system according to claim 6, wherein
information indicating a result of estimation of the material of the target object is output.

11. A material estimation method comprising:
acquiring information to be used for estimating a size of a particle in a particulate body constituting a target object, based on laser light with which the target object is irradiated and reflected light reflected by the target object;
estimating a size of a particle in the particulate body by using the information to be used for estimating a size of a particle; and
estimating a material of the target object, based on a result of estimation of the particle size.

12. The material estimation method according to claim 11, wherein
acquiring information relating to a distance to the target object, based on the laser light and the reflected light,
estimating a shape of the target object by using the information relating to a distance to the target object, and
estimating a material of the target object, based on a result of estimation of the shape and a result of estimation of the particle size.

13. The material estimation method according to claim 11, wherein
estimating a material of the target object by using a predetermined database, and
the database is updated based on a result of estimation of the material of the target object.

14. The material estimation method according to claim 11, wherein
the information to be used for estimating a size of a particle includes at least one of information indicating intensity of the reflected light being received, information indicating polarization of the reflected light being received, information indicating frequency deviation of the reflected light being received, and information indicating a statistic value of a distance to the target object.

15. The material estimation method according to claim 11, wherein
information indicating a result of estimation of the material of the target object is output.
